(19) United States
(12) Patent Application Publication
(10) Pub. No.: US 2009/0260031 A1
(43) Pub. Date: Oct. 15, 2009

(54) METHOD AND APPARATUS FOR REPRODUCING CONTENT

(75) Inventors: Tae-jeoung KIM, Suwon-si (KR); Woo-hyoung LEE, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/250,799

(22) Filed: Oct. 14, 2008

(30) Foreign Application Priority Data
Apr. 11, 2008 (KR) 10-2008-0033883

(51) Int. Cl. H04N 5/445

(52) U.S. Cl. 725/39

(57) ABSTRACT

A content reproducing method and apparatus that can provide an Internet protocol television (IPTV) based on electronic program guide (EPG) data. The content reproducing method includes detecting information of a program that a user is currently viewing or that the user has recently viewed from electronic program guide (EPG) data, receiving a content list from an Internet protocol television (IPTV) service server based on the detected program information, displaying the received content list, selecting content based on the displayed content list, and receiving and reproducing the selected content from the IPTV service server.

### CROSS-REFERENCE TO RELATED PATENT APPLICATIONS

This application claims priority from Korean Patent Application No. 10-2008-0033883 filed on Apr. 11, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to a content reproducing, and more particularly, to a content reproducing apparatus having a function of an Internet protocol television (IPTV) and a method thereof

2. Description of the Related Art

Content reproducing apparatuses can reproduce content that is input from outside or previously stored content. The content can include video, audio, video and audio, text information, and broadcasting programs. An Internet protocol television (IPTV) is a service providing information, video content, and broadcast programs by using a TV. The IPTV can provide, for example, a video on demand (VOD) service providing movie, soap opera, sports, etc. at a desired time, and a bi-directional service including live information such as newspapers, weather, finance, shopping, karaoke, a messaging service, etc. Content reproducing apparatuses having the functions of the IPTV reproduce content provided over the Internet.

Since content reproducing apparatuses having IPTV functionality provide services by using the TV as described above, the content reproducing apparatuses can have general TV functionalities.

Therefore, an operating mode of content reproducing apparatuses having the function of the IPTV that is currently commercialized can be divided into a TV mode and an IPTV mode. In more detail, when the operating mode is set as the TV mode, content reproducing apparatuses provide users with general TV functionalities, and when the operating mode is set as the IPTV mode, they operate in the IPTV mode and provide users with the above-described IPTV functionalities. Thus, users can use content reproducing apparatuses having the IPTV functionalities to selectively use the functions of the TV and the IPTV.

However, content reproducing apparatuses having the IPTV functionalities which are currently commercialized, do not interface the functions of the TV and the IPTV. Thus, when users desire to view a broadcasting program in the IPTV mode which was broadcast previous in time to a broadcasting program that is viewed in the TV mode, users have to memorize information relating to the broadcasting program (for example, a title of the broadcasting program) and search for the previous broadcasting program in the IPTV mode by using the memorized information as a keyword.

For example, when users desire to view a broadcasting program which was broadcast previous in time to a broadcasting program A while or after viewing the broadcasting program A, users have to memorize “A”, convert a content reproducing apparatus into the IPTV mode, input the memorized “A” as a keyword, and search for the previously broadcast program or the broadcasting program “A” based on a menu provided in the IPTV mode, which is a cumbersome process.

Furthermore, users have to search for the broadcasting program based on an input keyword or a keyword that users memorize, and thus a content search range is limited. For example, when “A” is a soap opera title and is used as a keyword to search for the broadcasting program, a broadcasting program having the soap opera title “A” is searched for but broadcasting programs having other information relating to the broadcasting program “A” is excluded from the search range. For example, when other information relating to the broadcasting program “A” is the name of an actor appearing in the broadcasting program “A”, another broadcasting program in which the actor appears is excluded from the search range.

### SUMMARY OF THE INVENTION

The present invention provides a content reproducing apparatus and method that can provide an Internet protocol television (IPTV) based on electronic program guide (EPG) data.

The present invention provides a content reproducing apparatus and method that interface functions of a TV and an IPTV.

The present invention provides a content reproducing apparatus and method of easily searching for content in an IPTV mode.

According to an aspect of the present invention, there is provided a content reproducing method comprising: detecting information of a program that a user is currently viewing or that the user has recently viewed from electronic program guide (EPG) data; receiving a content list from an Internet protocol television (IPTV) service server based on the detected program information; displaying the received content list; selecting content based on the displayed content list; and receiving and reproducing the selected content from the IPTV service server.

The receiving of the content list may comprise: defining the detected program information according to a communication protocol of the IPTV service server and requesting the IPTV service server to search for content.

The communication protocol of the IPTV service server may be an extensible markup language (XML) based protocol.

The XML based protocol may be a real simple syndication (RSS) protocol.

The EPG data may be program and system information protocol (PSIP) based information.

If the IPTV mode is established, the content reproducing method may be performed.

If a plurality of pieces of program information is detected, the content list may be received based on a piece of program information that is selected by the user from among the detected program information.

According to another aspect of the present invention, there is provided a content reproducing apparatus comprising: a detecting unit detecting information about a program that a user is currently viewing or that the user has recently viewed from EPG data; a transmitting/receiving unit transmitting the detected program information to an IPTV service server, and receiving a content list from the IPTV service server based on the detected program information; a display unit displaying the received content list; and a reproducing unit reproducing content selected based on the displayed content list.

The apparatus may further comprise: a controller controlling the detecting unit, the transmitting/receiving unit, the display unit, and the reproducing unit according to information that is input by the user.

The transmitting/receiving unit may define the detected program information according to a communication protocol of the IPTV service server and transmit the defined program information to the IPTV service server.

The communication protocol of the IPTV service server may be an XML based protocol.

The XML based protocol may be an RSS protocol.

The EPG data may be PSIP based information.

If an operating mode of the content reproducing apparatus is set to be an IPTV service mode, the controller may control the detecting unit, the transmitting/receiving unit, the display unit, and the reproducing unit.

The detecting unit may comprise: a first detecting unit detecting the EPG data from a received terrestrial wave bit-stream; and a second detecting unit detecting the program information from the EPG data detected by the first detecting unit.

The reproducing unit may comprise: a buffer storing the content received from the transmitting/receiving unit; a separating unit separating the content stored in the buffer into an image signal and an audio signal; and decoders decoding the image signal and the audio signal and transmitting the decoded signals to the display unit.

If a plurality of pieces of program information is detected by the detecting unit, the controller may display the information of the plurality of pieces of program information on the display unit, and if a piece of program information is selected from the displayed program information, the controller may transmit the selected program information to the IPTV service server via the transmitting/receiving unit.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a content reproducing apparatus according to an exemplary embodiment of the present invention;

FIG. 2 is a block diagram of a network applicable to the content reproducing apparatus according to an exemplary embodiment of the present invention;

FIG. 3 is a block diagram of a network applicable to the content reproducing apparatus according to another exemplary embodiment of the present invention;

FIG. 4 is a flowchart illustrating a content reproducing method according to an exemplary embodiment of the present invention;

FIG. 5 is a flowchart illustrating operations between a content reproducing apparatus and peripheral devices based on a content reproducing method according to an exemplary embodiment of the present invention;

FIG. 6 is a flowchart illustrating a content reproducing method according to another exemplary embodiment of the present invention; and

FIG. 7 is a flowchart illustrating operations between a content reproducing apparatus and peripheral devices based on the network applicable to the content reproducing apparatus according to an exemplary embodiment of the present invention.

### DETAILED DESCRIPTION OF EXEMPLARY EMBODIMENTS OF THE INVENTION

Exemplary embodiments of the present invention provide a content reproducing method and apparatus for searching for content in an Internet protocol television (IPTV) mode based on electronic program guide (EPG) data that is received via a terrestrial wave bit-stream. Therefore, a user does not need to previously memorize program data in order to search for content in the IPTV mode but can establish a content search range based on the EPG data.

Furthermore, another exemplary embodiment of the present invention can realize a content reproducing method and apparatus to establish a hub unit or a hub size between the content reproducing apparatus and an IPTV service server.

Hereinafter, exemplary embodiments of the present invention will be described in detail with reference to the accompanying drawings.

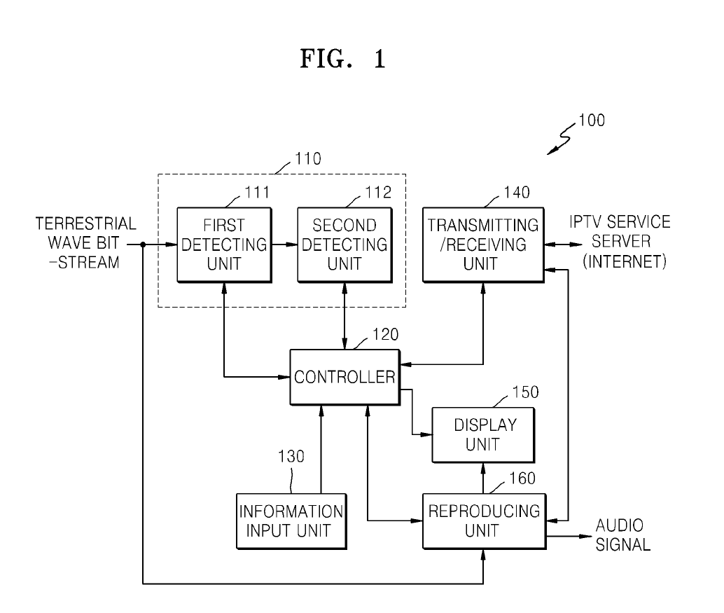

FIG. 1 is a block diagram of a content reproducing apparatus 100 according to an exemplary embodiment of the present invention. The content reproducing apparatus 100 is capable of providing TV functionality and connecting to the Internet and represents a content reproducing apparatus having an IPTV service function.

Referring to FIG. 1, the content reproducing apparatus 100 comprises a detecting unit 110, a controller 120, an information input unit 130, a transmitting/receiving unit 140, a display unit 150, and a reproducing unit 160.

The detecting unit 110 receives a terrestrial wave bit-stream and detects information about a program that a user is currently viewing or that the user has recently viewed. The terrestrial wave bit-stream can be defined as a terrestrial wave transport stream or a live stream. The terrestrial wave bit-stream is provided from a content provider (not shown). The content provider may be, for example, a broadcasting station.

The detecting unit 110 can detect the information according to or irrespective of control by the controller 120. The control by the controller 120 is a control to determine whether to detect the information.

The detecting unit 110 can detect the information based on information provided by the controller 120 regarding the program that the user is currently viewing or that the user has recently viewed. The information may be, for example, channel information and time information.

The detecting unit 110 may comprise a first detecting unit 111 and a second detecting unit 112.

The first detecting unit 111 detects EPG data from the received terrestrial wave bit-stream. If the EPG data is based on a program and system information protocol (PSIP), the first detecting unit 111 performs PSIP parsing with regard to the received terrestrial wave bit-stream and detects the EPG data from the terrestrial wave bit-stream. The PSIP is used to transmit information on each channel of a transport stream according to the advanced television system committee (ATSC) digital TV standard. The first detecting unit 111 transmits the detected EPG data to the second detecting unit 112.

The second detecting unit 112 detects the information about the program that the user is currently viewing or that the user has recently viewed from the EPG data based on the information provided from the controller 120. In this regard, the detected information may be a title, an actor's name, etc.

For example, if the second detecting unit 112 receives channel 11 and current time information from the controller 120, the second detecting unit 112 can detect entire EPG data including a title and an actor's name of a program that is currently being broadcast via channel 11 from the EPG data. Alternatively, the second detecting unit 112 can detect the program information from the EPG data based on time information at the time the IPTV mode is established or when a TV mode is changed to the IPTV mode and based on channel information of a program that ends at the time the IPTV mode is established or when the TV mode is changed to the IPTV mode. The second detecting unit 112 transmits the program information detected from the EPG data to the controller 120.

The controller 120 can provide the second detecting unit 112 with the information about the program that the user is currently viewing or that the user has recently viewed irrespective of information that is input from the information input unit 130. However, if the information input unit 130 inputs information requesting the establishment of the IPTV or information requesting the change from the TV mode to the IPTV mode, the controller 120 can provide the second detecting unit 112 with the program information.

The controller 120 collects the information of the program that the user is currently viewing or that the user has recently viewed while controlling the operation of the content reproducing apparatus 100. For example, the controller 120 collects information of a channel selected according to the information that is input from the information input unit 130 as channel information, and collects time information at the time the establishment of the IPTV mode is requested or when the change from the TV mode to the IPTV mode is requested, by monitoring a timer (not shown) included in the content reproducing apparatus 100.

However, the controller 120 can provide the second detecting unit 112 with the program information irrespective of the information that is input from the information input unit 130, and can receive the program information that is detected by the second detecting unit 112. In this case, the controller 120 stores the program information received from the second detecting unit 112, and updates the stored program information when receiving new program information from the second detecting unit 120. For example, when the user changes a viewing channel from channel 11 to channel 9, since the program information that is detected by the second detecting unit 112 is changed, the controller 120 updates the stored program information.

Furthermore, the controller 120 determines whether a plurality of pieces of program information are transmitted from the second detecting unit 112. If a plurality of pieces of program information are not transmitted from the second detecting unit 112 and the information input unit 130 requests the establishment of the IPTV mode or the change from the TV mode to the IPTV mode, the controller 120 transmits the program information transmitted from the second detecting unit 112 to the transmitting/receiving unit 140.

If a plurality of pieces of program information are transmitted from the second detecting unit 112, the controller 120 displays the plurality of pieces of program information on the display unit 150. The user views the program information that is displayed on the display unit 150 and can select a desired keyword used to select content in the IPTV mode. If the user inputs information for selecting a piece of program information via the information input unit 130 based on the program information that is displayed on the display unit 150, the controller 120 transmits the selected program information to the transmitting/receiving unit 140.

For example, when the display unit 150 displays a program title and an actor's name, if the user selects the actor's name, the controller 120 transmits the actor's name to the transmitting/receiving unit 140 as the selected program information.

The transmitting/receiving unit 140 transmits the program information received from the controller 120 to an IPTV service server (not shown), and receives a content list based on the program information from the IPTV service server. The transmitting/receiving unit 140 defines program information that is to be transmitted according to a communication protocol of the IPTV service server and can transmit the program information to the IPTV service server.

For example, if the program information is an actor's name “HAN”, and the IPTV service server uses real simple syndication (RSS) as the communication protocol, the transmitting/receiving unit 140 defines the actor's name “HAN” as “http://www.vod.com/search,asp?field=name?name=HAN” and can transmit the program information to the IPTV service server. The communication protocol can be defined as an extensible markup language (XML) based protocol. The XML based protocol can be defined as an RSS based protocol.

Furthermore, for example, if the program information is a program title “B”, and the IPTV service server uses the RSS as the communication protocol, the transmitting/receiving unit 140 defines the program title “B” as “http://www.vod.com/search,asp?filed1=title?name=B” and can transmit the program information to the IPTV service server. The communication protocol can be defined as the XML based protocol. The XML based protocol can be defined as an RSS based protocol.

However, when a hub unit (or a hub site) is established between the content reproducing apparatus 100 and the IPTV service server, the transmitting/receiving unit 140 transmits the received program information directly to the hub unit. The hub unit can define the program information according to a protocol of the IPTV service server and transmits the program information to the IPTV service server. In more detail, if the transmitting/receiving unit 140 transmits the actor's name “HAN” to the hub unit (not shown), the hub unit defines the actor's name “HAN” as “http://www.vod.com/search,asp?field=name?name=HAN” and can transmit the program information to the IPTV service server.

The transmitting/receiving unit 140 transmits the content list received from the IPTV service server to the controller 120. The controller 120 receives the content list from the transmitting/receiving unit 140 and displays the received content list on the display unit 150.

When a plurality of pieces of program information is detected from the content list and by the second detecting unit 112 according to the controlling of the controller 120, the display unit 150 displays a screen for selecting one of the plurality of pieces of program information. Furthermore, the display unit 150 displays an image signal that is reproduced by the reproducing unit 160.

If the information input unit 130 inputs information used to select content that is desired to be reproduced based on the content list displayed on the display unit 150, the controller 120 sends the content select information to the IPTV service server via the transmitting/receiving unit 140. Therefore, the transmitting/receiving unit 140 receives the selected content, and transmits the received content to the reproducing unit 160. At this time, the transmitting/receiving unit 140 operates a protocol engine (not shown) and analyzes information transmitted from the IPTV service server.

The reproducing unit 160 reproduces the received terrestrial wave bit-stream or the content received through the transmitting/receiving unit 140 according to the controlling of the controller 120. In more detail, in order to reproduce the content received from the transmitting/receiving unit 140, the reproducing unit 160 comprises a buffer (not shown) storing the content received from the transmitting/receiving unit 140, a separating unit (not shown) separating the content stored in the buffer into an image signal and an audio signal, and decoders (not shown) decoding the image signal and the audio signal that are separated by the separating unit. The reproducing unit 160 can be realized by using the separating unit and the decoders in order to reproduce the received terrestrial wave bit-stream. The reproducing unit 160 can be realized by using a codec.

The controller 120 controls the detecting unit 110, the transmitting/receiving unit 140, the display unit 150, and the reproducing unit 160 according to the information that is input by the user.

The content reproducing apparatus 100 of an exemplary embodiment can have a tuner function of receiving a terrestrial broadcasting signal and a set-top box function of performing the IPTV function. The set-top box function of performing the IPTV function can be performed by the transmitting/receiving unit 140.

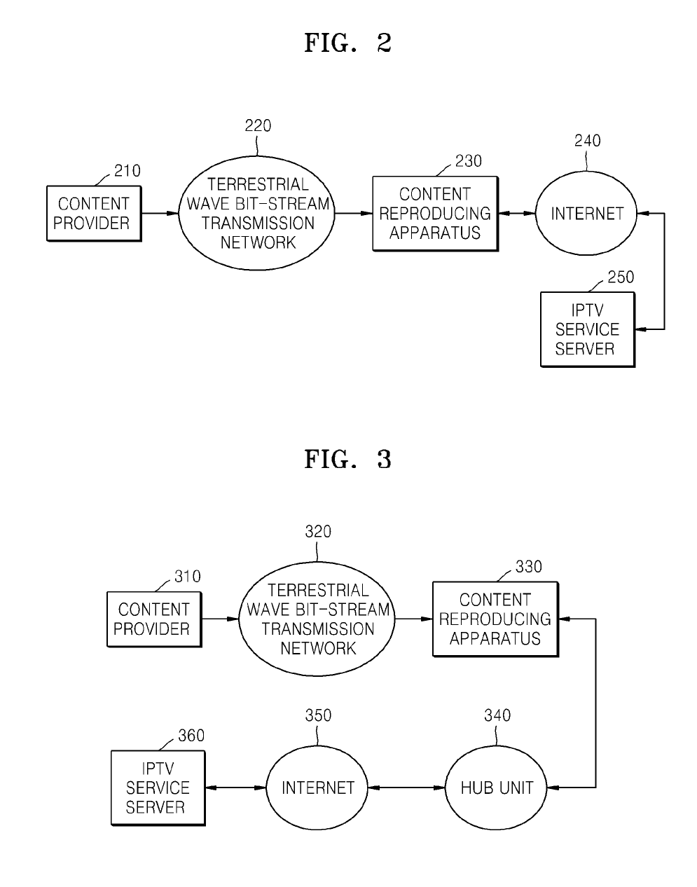

FIG. 2 is a block diagram of a network where the transmitting/receiving unit 140 of the content reproducing apparatus 100 shown in FIG. 1 defines program information according to a communication protocol of an IPTV service server 250 according to an exemplary embodiment of the present invention. Referring to FIG. 2, the network of an exemplary embodiment comprises a content provider 210, a terrestrial wave bit-stream transmission network 220, a content reproducing apparatus 230, Internet 240, and the IPTV service server 250. The content provider 210 may be a broadcasting station. The terrestrial wave bit-stream transmission network 220 may be a network able to transmit a broadcasting program that is sent from the broadcasting station. The content reproducing apparatus 230 may correspond to the content reproducing apparatus 100 shown in FIG. 1. The Internet 240 may be the currently known Internet. The IPTV service server 250 is a server which is able to provide an IPTV service.

FIG. 3 is a block diagram of a network where the transmitting/receiving unit 140 of the content reproducing apparatus 100 shown in FIG. 1 does not define program information according to a communication protocol of an IPTV service server 360, according to an exemplary embodiment of the present invention. Referring to FIG. 3, the network of an exemplary embodiment comprises a content provider 310, a terrestrial wave bit-stream transmission network 320, a content reproducing apparatus 330, a hub unit 340, Internet 350, and the IPTV service server 360. The hub unit 340 defines program information that is output from the content reproducing apparatus 330 according to the communication protocol of the IPTV service server 360, transmits the defined program information to the IPTV service server 360, and transmits a content list transmitted from the IPTV service server 360 in accordance with the communication protocol of the content reproducing apparatus 330 to the content reproducing apparatus 300. The content provider 310, the terrestrial wave bit-stream transmission network 320, Internet 350, and the IPTV service server 360 are configured in a similar manner, respectively, to the content provider 210, the terrestrial wave bit-stream transmission network 220, Internet 240, and the IPTV service server 250 shown in FIG. 2.

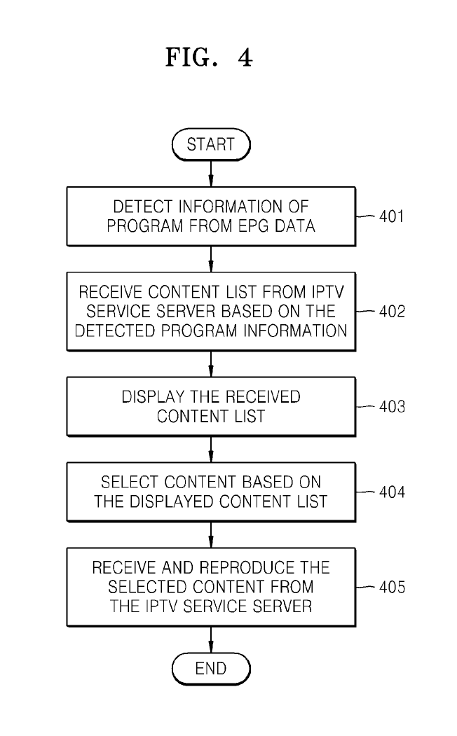

FIG. 4 is a flowchart illustrating a content reproducing method according to an exemplary embodiment of the present invention. Referring to FIG. 4, information of a program that a user is currently viewing or that the user has recently viewed is detected from EPG data (operation 401). The EPG data may be PSIP-based information.

A content list is received from an IPTV service server based on the detected program information (operation 402). In operation 402, the detected program information is defined according to a communication protocol of the IPTV service server and the IPTV service server is requested to search for content. The communication protocol of the IPTV service server may be an XML based protocol. The XML based protocol may be an RSS based protocol.

The received content list is displayed (operation 403). If content is selected based on the displayed content list (operation 404), the selected content is received from the IPTV service server and is reproduced (operation 405). The content reproducing method can be performed if an IPTV service mode is established.

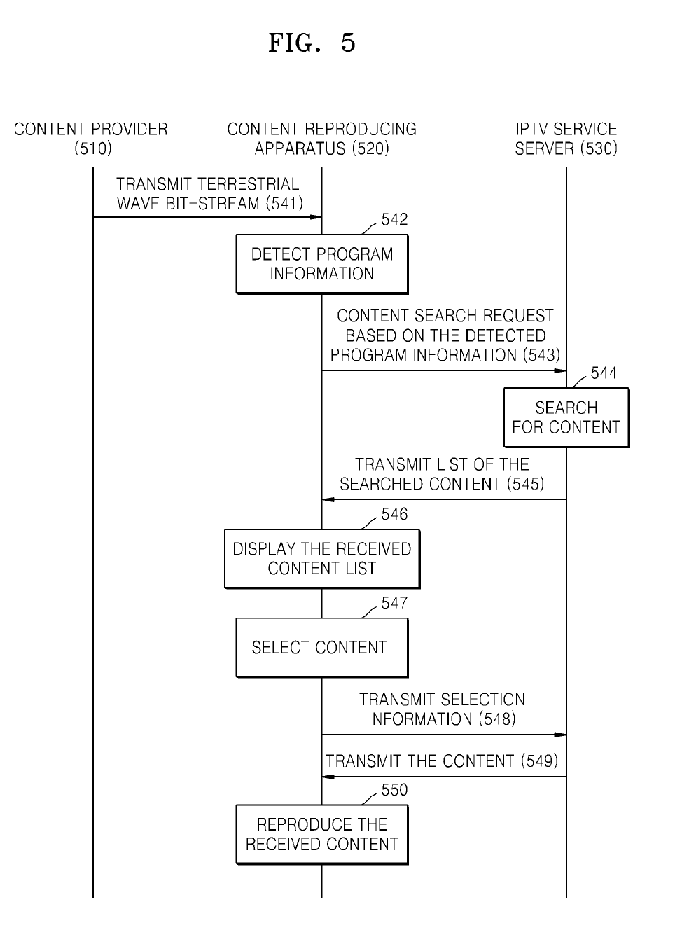

FIG. 5 is a flowchart illustrating the content reproducing method shown in FIG. 4 between a content provider 510, a content reproducing apparatus 520, and an IPTV service server 530 according to an exemplary embodiment of the present invention. Referring to FIG. 5, if the content provider 510 transmits a terrestrial wave bit-stream to the content reproducing apparatus 520 (operation 541), the content reproducing apparatus 520 detects program information (operation 542). If the program information is detected, the content reproducing apparatus 520 transmits a content search request to the IPTV service server 530 based on the detected program information (operation 543).

The IPTV service server 530 searches for content (operation 544), and transmits a list of the searched content to the content reproducing apparatus 520 (operation 545). The content reproducing apparatus 520 displays the received content list (operation 546), and if a piece of content based on the displayed content list is selected (operation 547), transmits selection information to the IPTV service server 530 (operation 548).

The content reproducing apparatus 520 receives the content from the IPTV service server 530 (operation 549), and reproduces the received content (operation 550).

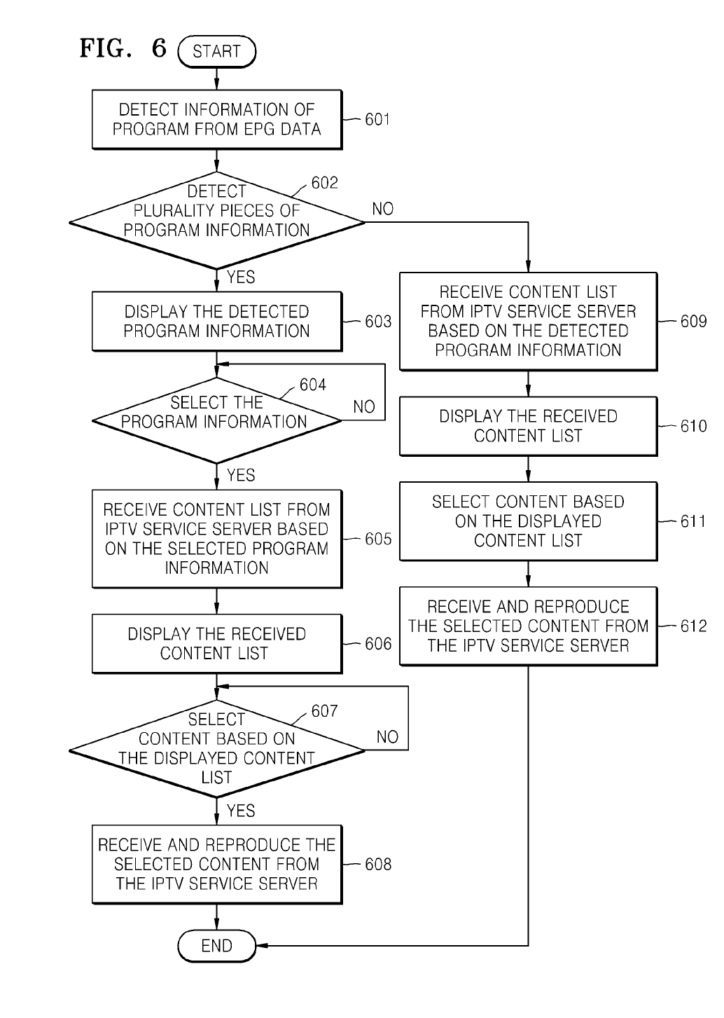

FIG. 6 is a flowchart illustrating a content reproducing method according to another exemplary embodiment of the present invention. Referring to FIG. 6, the content reproducing method further comprises an operation of selecting program information according to whether a plurality of pieces of program information are detected by using the content reproducing method shown in FIG. 4.

Information about a program that a user is currently viewing or that the user has recently viewed is detected from EPG data (operation 601). The EPG data may be PSIP-based information.

If a plurality of pieces of program information is detected, the detected program information is displayed (operations 602 and 603). If one or more pieces of the program information is selected based on the displayed program information (operation 604), a content reproducing apparatus receives a content list from an IPTV service server based on the selected program information (operation 605). In operation 605, the selected program information can be defined according to a communication protocol of the IPTV service server and the IPTV service server can be requested to search for content. The communication protocol of the IPTV service server may be an XML based protocol. The XML based protocol may be an RSS based protocol.

The received content list is displayed (operation 606). If content is selected based on the displayed content list (operation 607), the selected content is received from the IPTV service server and is reproduced (operation 608).

Meanwhile, if a plurality of pieces of program information are not detected in operation 602, the selected content is reproduced in operations 609 through 612 similar to that as described in operations 402 through 405, respectively, as shown in FIG. 4.

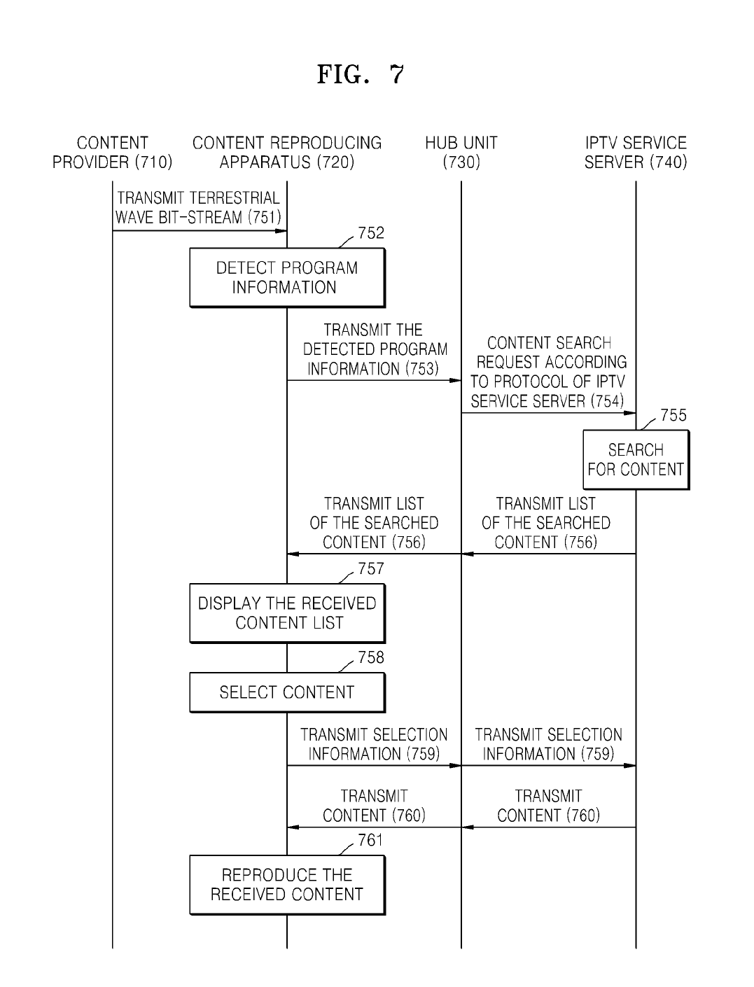

FIG. 7 is a flowchart illustrating a content reproducing method between a content provider 710, a content reproducing apparatus 720, a hub unit 730, and an IPTV service server 740 when the hub unit 340 is coupled between the content reproducing apparatus 330 and the IPTV service server 360 shown in FIG. 3 according to an exemplary embodiment of the present invention. Referring to FIG. 7, if the content provider 710 transmits a terrestrial wave bit-stream to the content reproducing apparatus 720 (operation 751), the content reproducing apparatus 720 detects program information (operation 752). If the program information is detected, the content reproducing apparatus 720 transmits the detected program information to the hub unit 730 (operation 753). The hub unit 730 transmits a content search request according to a protocol of the IPTV service server 740 based on the program information to the IPTV service server 740 (operation 754).

The IPTV service server 740 searches for content (operation 755), and transmits a list of the searched content to the content reproducing apparatus 720 via the hub unit 730 (operation 756). The content reproducing apparatus 720 displays the received content list (operation 757), and if a piece of content based on the displayed content list is selected (operation 758), transmits selection information to the IPTV service server 740 via the hub unit 730 (operation 759).

The content reproducing apparatus 720 receives the content from the IPTV service server 740 via the hub unit 730 (operation 760), and reproduces the received content (operation 761).

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

In another exemplary embodiment of the present invention, the computer readable medium may include carrier waves (such as data transmission through the Internet).

The computer readable recording medium can also be distributed network coupled computer systems so that the computer readable code is stored and executed in a distributed fashion.

A content reproducing apparatus having IPTV functionality according to exemplary embodiments of the present invention searches for content in an IPTV mode based on EPG data, so that a user can more easily enjoy an IPTV service and extend a content search range.

Furthermore, the content reproducing apparatus is realized to establish a hub site (or a hub unit), thereby supporting various service providers and service types.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A content reproducing method comprising:
detecting information of a program that a user is currently viewing or that the user has recently viewed from electronic program guide (EPG) data;
receiving a content list from an Internet protocol television (IPTV) service server based on the detected program information;
displaying the received content list;
selecting a desired content based on the displayed content list; and
receiving and reproducing the selected desired content from the IPTV service server.

2. The method of claim 1, wherein the receiving the content list comprises:
defining the detected program information according to a communication protocol of the IPTV service server and requesting the IPTV service server to search for content with which the content list is populated.

3. The method of claim 2, wherein the communication protocol of the IPTV service server is an extensible markup language (XML) based protocol.

4. The method of claim 3, wherein the XML based protocol is a real simple syndication (RSS) protocol.

5. The method of claim 1, wherein the EPG data comprises program and system information protocol (PSIP) based information.

6. The method of claim 1, wherein, if an IPTV mode is established, the content reproducing method is performed.

7. The method of claim 1, wherein if a plurality of pieces of program information is detected, the content list is received based on a piece of program information that is selected by the user from among the detected plurality of pieces of program information.

8. A content reproducing apparatus comprising:
a detecting unit which detects information of a program that a user is currently viewing or that the user has recently viewed from electronic program guide (EPG) data;
a transmitting/receiving unit which transmits the detected program information to an Internet protocol television (IPTV) service server, and receives a content list from the IPTV service server based on the detected program information;
a display unit which displays the received content list; and
a reproducing unit which reproduces a desired content selected based on the displayed content list.

9. The apparatus of claim 8, further comprising: a controller which controls the detecting unit, the transmitting/receiving unit, the display unit, and the reproducing unit according to information that is input by the user.

10. The apparatus of claim 8, wherein the transmitting/receiving unit defines the detected program information according to a communication protocol of the IPTV service server and transmits the defined program information to the IPTV service server.

11. The apparatus of claim 10, wherein the communication protocol of the IPTV service server is an extensible markup language (XML) based protocol.

12. The apparatus of claim 11, wherein the XML based protocol is a real simple syndication (RSS) protocol.

13. The apparatus of claim 8, wherein the EPG data comprises program and system information protocol (PSIP) based information.

14. The apparatus of claim 8, further comprising a controller, wherein if an operating mode of the content reproducing apparatus is set to be an IPTV service mode, the controller controls the detecting unit, the transmitting/receiving unit, the display unit, and the reproducing unit to reproduce the desired content.

15. The apparatus of claim 8, wherein the detecting unit comprises:
a first detecting unit which detects the EPG data from a received terrestrial wave bit-stream; and
a second detecting unit which detects the program information from the EPG data detected by the first detecting unit.

16. The apparatus of claim 8, wherein the reproducing unit comprises:
a buffer which stores the desired content received from the transmitting/receiving unit;
a separating unit which separates the desired content stored in the buffer into an image signal and an audio signal; and
a plurality of decoders which decode the image signal and the audio signal and transmits the decoded image and audio signals to the display unit.

17. The apparatus of claim 9, wherein if a plurality of pieces of program information is detected by the detecting unit, the controller displays the information of the plurality of pieces of program information on the display unit, and if a piece of program information is selected from the displayed plurality of pieces of program information, the controller transmits the selected piece of program information to the IPTV service server via the transmitting/receiving unit.
